(19) United States
(12) Patent Application Publication
(10) Pub. No.: US 2008/0007125 A1
(43) Pub. Date: Jan. 10, 2008

(54) Active vibration damper

(75) Inventors: Hironori Koyama, Kasugai-shi (JP); Atsushi Muramatsu, Komaki-shi (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., KOMAKI-SHI (JP)

(21) Appl. No.: 11/806,817

(22) Filed: Jun. 4, 2007

(30) Foreign Application Priority Data
Jun. 21, 2006 (JP) 2006-171891

(51) Int. Cl. H02K 33/00

(52) U.S. Cl. 310/27; 267/140.14

(57) ABSTRACT

An active vibration damper including: an electric-type linear actuator having a stator, a movable member; a coil arranged in one of the stator and the movable member; a mounting member to which the stator is fixed; a mass member incorporating the movable member; an elastic connecting rubber connecting the mass member to the stator, and being disposed such that the linear actuator is disposed on one side thereof so that the mass member is oscillated by means of driving force applied to the movable member of the linear actuator; a cover member firmly fixed to the mounting member for providing a hermetic accommodation space having a first air chamber and a second air chamber formed on both sides of the elastic connecting rubber; and an air channel through which the first and the second air chambers are communicated.

### INCORPORATED BY REFERENCE

The disclosure of Japanese Patent Application No. 2006-171891 filed on Jun. 21, 2006 including the specification, drawings and abstract is incorporated herein by reference in its entirety.

### BACKGROUND OF THE INVENTION

1. Field of the Invention

The present invention relates to an active vibration damper that is mounted on a target member whose vibration to be damped, and that is able to attenuate vibration in the target member in an active or offset fashion.

2. Description of the Related Art

As one means for reducing an oscillation of a target member to be kept in a vibration damped state, like an automotive body, there is known an active vibration damper. The active vibration damper is mounted on the target member, and excites oscillation force corresponding to the oscillation of the target member, thereby actively damping or offsetting vibration in the target member. U.S. Pat. No. 6,907,969 discloses one example of such an active vibration damper.

Such an active vibration damper is equipped with an actuator for generating oscillating force corresponding to the vibration in the target member. More specifically, the actuator includes: a stator adapted to be fixed to the target member; and a movable member that is displaceable relative to the stator in the output direction of oscillating force. The stator and movable member are elastically connected with each other by means of an elastic connecting rubber. Although an air-type actuator which makes a movable member drive by using air pressure is proposed, the linear actuator of an electric type is suitably adopted for an active vibration damper. Namely, in order to demonstrate excellent vibration damping or isolating effect, the active vibration damper needs an actuator capable of exciting oscillating force highly precisely corresponding to the vibration in the target member. Since the electronic-type linear actuator is able to exhibit desired oscillation force with stability by highly precisely designing an initial positioning between the stator and the movable member, the electronic-type linear actuator is preferably employed for realizing excellent vibration damping effect.

A variety types of electronic-type linear actuators are available nowadays. The aforementioned document U.S. Pat. No. 6,907,969 discloses one example of the electronic-type linear actuators wherein the stator is equipped with a cylindrical coil component, and the movable member is equipped with a yoke member disposed co-axially with the coil component and inserted into the coil component, while a permanent magnet is located in a perimeter side of the coil component. As a result of operation of the magnetic field generated upon energizing the coil of the coil component, the movable member is forced to move relative to the stator, so that desired oscillation force will be generated.

The active vibration damper which adopts the electric-type linear actuator is able to acquire excellent damping effect with the help of the stable oscillation of the mass member by the stable generative force. On the other hand, this type of active vibration damper is likely to suffer from possible malfunction by debris, such as water and dust, entry into the inside of the actuator, since the actuator is electrically operated. To cope with this problem, the aforementioned document U.S. Pat. No. 6,907,969 proposes that the electric-type linear actuator is housed within a hermetically closed accommodation space (air chamber) that is defined by a case of the active vibration damper in the form of a round tubular shape having a bottom and an elastic connecting rubber that is disposed so as to close the opening of the case. This arrangement makes it possible to effectively prevent entry of water and dust from the external side into the inside of the linear actuator, thereby avoiding malfunction by debris entered into the actuator and the resultant deterioration in operation precision of the actuator.

However, in the electric type linear actuator, due to heat arising by energizing the coil, the air in the sealed accommodation space (sealing territory between the case and elastic connecting rubber) may warm and expand by generation of heat by the coil. As a result, the pressure in accommodation space may become high as compared with the pressure of exterior space. In such a case, the elastic connecting rubber, which elastically connects between the movable member and the stator, may undergo swell deformation toward the opposite side from the accommodation space due to the pressure differential of the air of the both sides which sandwich elastic connecting rubber.

The above-described unexpected deformation of the elastic connecting rubber may cause dislocation in the non oscillation condition between the stator and the movable member, which are connected to each other via the elastic connecting rubber. In this case, it becomes difficult to obtain the target oscillating force with sufficient accuracy. As a result, the active vibration damper is disable to exhibit desired damping effect. Furthermore, the unexpected elastic deformation of the elastic connecting rubber may possibly cause a change in the spring constant of the elastic connecting rubber in the driving direction of the movable member. Therefore, the target damping effect may no longer be effectively demonstrated. It is also considered that a smooth displacement of the movable member is barred by spring operation of the air sealed by accommodation space, and the desired oscillating force and damping effect cannot be acquired effectively.

If an air hole is prepared in the component which constitutes the wall portion of accommodation space, e.g. the elastic connecting rubber and the case in order to open the accommodation space to the external area through the air hole, it may become impossible to completely avoid entry of water or dusts into the linear actuators by making accommodation space into a sealed state to the external space. Therefore, a malfunction of the linear actuator, instability of oscillation force, and the like may pose a problem again.

To cope with this problem, JP 2001-227581A discloses the improved construction which made it possible to prevent entry into actuators, such as water and a particulate. Namely, the wall portion of accommodation space has the air hole which opens accommodation space (air chamber) to the external area, and this air hole is covered by a permeability waterproof membrane, thereby permitting flow of the air between accommodation space and exterior space, while preventing the entry of the water and dusts into the actuator.

However, the construction proposed by the aforementioned JP 2001-227581A specially needs the permeability waterproof membrane which combines permeability and waterproofness, so that the device is likely to suffer from the problems of increased number of components and complicated construction of the device. Further, the operation for affixing the membrane to the active vibration damper is needed, thereby increasing the number of manufacturing processes.

### SUMMARY OF THE INVENTION

It is therefore one target of this invention to provide an active vibration damper of novel construction, which is able to completely prevent entry of debris, such as water and dusts, into the linear actuator of electric type, and is able to stably exhibit excellent damping effect based on oscillation force highly precisely generated by the electric type linear actuator.

The above and/or optional objects of this invention may be attained according to at least one of the following aspects or features of the invention. The following features and/or elements employed in each aspect of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first aspect of the present invention provides an active vibration damper comprising: an electric-type linear actuator including a stator, a movable member disposed displaceable relative to the stator; and a coil arranged in one of the stator and the movable member, the coil being energized to generate a magnetic field that exerts a force on the movable member to drive the movable member relative to the stator; a mounting member to which the stator of the linear actuator is fixed; a mass member constituted by incorporating the movable member of the linear actuator; an elastic connecting rubber connecting the mass member to the stator, and being disposed such that the linear actuator is disposed on one side of the elastic connecting rubber in a direction of displacement of the movable member relative to the stator so that the mass member is oscillated by means of driving force applied to the movable member of the linear actuator; a cover member firmly fixed to the mounting member for providing a hermetic accommodation space wherein the linear actuator and the elastic connecting rubber are housed, the hermetic accommodation space are divided into a first air chamber formed on one side of the elastic connecting rubber and housing the linear actuator therein, and a second air chamber formed on an other side of the elastic connecting rubber; and an air channel for permitting communication between the first air chamber and the second air chamber.

In the active vibration damper according to the first aspect of the present invention, the electric-type linear actuator is housed within the hermitic accommodation space formed by the cover member, and the hermitic accommodation space is air tightly closed from the external area by means of the cover member. Therefore, entry of debris, such as water and dusts into the electric-type linear actuator is highly prevented, and malfunction or defects of the device can be effectively prevented.

In the electric-type linear actuator, especially, the gap formed between components (a stator and a movable member) is made small to improve output efficiency. Therefore, if dusts or the like enters into the gap between the components, the operation of the actuator may possibly be deteriorated due to sticking or the like caused by the dusts. In the present embodiment, the linear actuator is disposed within the hermitic accommodation space, so that the entry of dusts or the like from the outside area into the actuator is highly avoidable. Therefore, the gap formed between components (a stator and a movable member) can be made small enough, and improvement in output efficiency etc. can also be achieved at with the stable output performance.

Moreover, even if the air in the first air chamber by warms and expands by generation of heat due to actuation of an electric-type linear actuator, since the first air chamber and the second air chamber are held in mutual communication through the air channel, the pressure differential produced between the first air chamber and the second air chamber can be cancelable as soon as possible. This arrangement is able to prevent advantageously the elastic connecting rubber which separates the first air chamber and the second air chamber from undergoing unexpected deformation due to the pressure differential of both chambers. Therefore, the relative location of the stator and the movable member is able to be positioned with high precision, and the desired oscillation force can be obtained with sufficient accuracy. Therefore, the present vibration damper is able to realize the highly precise vibration damping depending on a target member whose vibration to be damped. It should be noted that the above-described enhanced effect of the present invention can be realized by a simple structure where the two air chamber are connected together through the air channel, without needing a special component such as a permeability canal film or the like.

In addition, by preventing the unexpected elastic deformation of the elastic connecting rubber, it becomes possible to avoid change of the spring characteristics by the shape change of elastic connecting rubber. Thus, the desired oscillating force is generated with high precision, and an expected damping effect can be acquired effectively.

Even in the case where the first air chamber and the second air chamber which are formed in the both sides of elastic connecting rubber are both air-tightly sealed from the exterior space, the first air chamber and the second air chamber of these sealed states open to each other through the channel. This arrangement makes it possible to reduce or avoid the actuation of the movable member due to an air spring, whereby the active vibration damper of the present invention is able to effectively provide desired damping effect.

The cover member is desirable to form by rigid materials, such as metal, for the purpose of implementation of sufficient durability etc. Alternatively, a part or the whole of the cover member is formed with a soft material in order to reduce a rising of the pressure in sealing accommodation space.

In one preferred arrangement of the present invention, the stator includes a stator side inner member firmly fixed to the stator, and the movable member includes a movable member side outer tubular member firmly fixed to the movable member and disposed coaxially with the stator side inner member while being spaced from each other in an axis-perpendicular direction, the elastic connecting rubber is disposed between opposing faces between the stator side inner member and the movable member side outer tubular member for elastically connecting the stator and the movable member, and a fixation shaft member extending in an axial direction is disposed such that both axial ends of the fixation shaft member are fixed to the cover member, and the stator side inner member is firmly fixed to the fixation shaft member.

According to this arrangement, by attaching the stator (stator side inner member) fixedly to the fixation shaft member that is firmly fixed at its axial both ends to the cover member, the state is stably fixed to the cover member as well as the target member whose vibration to be damped. As a result, oscillation force generated by the electric-type linear actuator is stably transmitted to the target member to be damped, whereby the active dynamic damper of the present invention can exhibit effectively damping performance.

In another preferred arrangement of the present invention, the movable member is disposed radially inwardly of the cover member with a given gap interposed therebetween in the axis-perpendicular direction, and the air channel is formed by utilizing the given gap between the movable member and the cover member. When the electric-type linear actuator is of structure wherein the stator side inner member is fixed to the stator side allocated in the inner circumference side and the movable member side outer tubular member is fixed to the movable member side allocated in the perimeter side, in order to realize relative actuation of the stator to the movable member, a gap is formed between the cover member and movable member which is attached to the stator side. Therefore, it is not necessary to secure the special space for an air channel, so that the active vibration damper of the present invention can be compactly realized with sufficient space utilization by forming the air channel using this gap.

In yet another preferred arrangement of the present invention, the stator side inner member has a through hole extending therethrough in an axial direction thereof, and the air channel is formed by using the through hole. With this arrangement, if the current carrying part, such as coil, is arranged to the stator side (stator side inner member), the air channel can be formed by utilizing the through hole formed through the stator side inner member, so that the temperature gradient between the first air chamber and the second air chamber can be reduced effectively.

In still another preferred arrangement of the present invention, the active vibration damper further comprises an movable member side inner member firmly fixed to the movable member; and a stator side outer tubular member firmly fixed to the stator member and disposed coaxially with the movable member side inner member while being spaced from each other in an axis-perpendicular direction. The elastic connecting rubber is disposed between opposing faces between the movable member side inner member and the stator side outer tubular member for elastically connecting the stator and the movable member. The movable member side inner member has a through hole extending therethrough in an axial direction thereof, and the air channel is formed by using the through hole.

In the case where the electric-type linear actuator has a structure where the stator is disposed at the perimeter side and no gap is needed between the linear actuator and the cover member, this arrangement makes it possible to form the air channel to the side of the movable side inner member that is firmly fixed to the movable member disposed radially inner side. Therefore, the active vibration damper of the present invention can be realized in a compact form while avoiding an increase in side of the damper in the axis-perpendicular direction.

In yet another preferred arrangement of the present invention, the movable member includes an inner tubular member extending in the axial direction and firmly fixed to the movable member side inner member. One axial open end of the inner tubular member is held in communication with the first air chamber, and an other axial open end of the inner tubular member is held in communication with the second air chamber through the through hole of the movable member side inner member so that the air channel is formed by utilizing a bore of the inner tubular member and the through hole of the movable member side inner member.

According to this arrangement, since the air channel is formed by utilizing the inner tubular member extending in the axial direction, the location of an air inlet to the side of the first air chamber can be adjusted depending on the position of the heating elements (current-carrying part of the electric-type linear actuator etc.), which causes a temperature change. Therefore, the temperature gradient produced between the first air chamber and the second air chamber can be reduced, thereby making it possible to reduce problems, such as lowering of the actuation accuracy resulting from the temperature gradient between both chambers. That is, by adjusting the axial length of the inner tubular member etc., it becomes possible to adjust the opening position on the side of the first air chamber of the air channel so that the air, which has been warmed in the first air chamber, may flow in the second air chamber promptly.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is an elevational view in axial or vertical cross section of an active vibration damper of construction according to a first embodiment of the invention, taken along line 1-1 of FIG. 2;

FIG. 2 is a cross sectional view taken along line 2-2 of FIG. 1;

FIG. 3 is an elevational view in axial or vertical cross section of an active vibration damper of construction according to a second embodiment of the invention; and

FIG. 4 is an elevational view in axial or vertical cross section of an active vibration damper of construction according to a third embodiment of the invention.

### DETAILED DESCRIPTION OF PREFERRED EMBODIMENTS

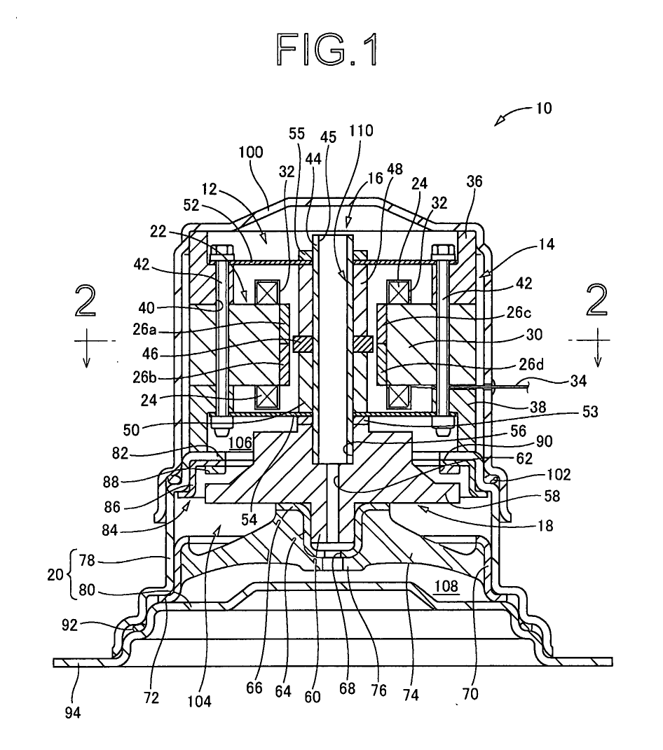

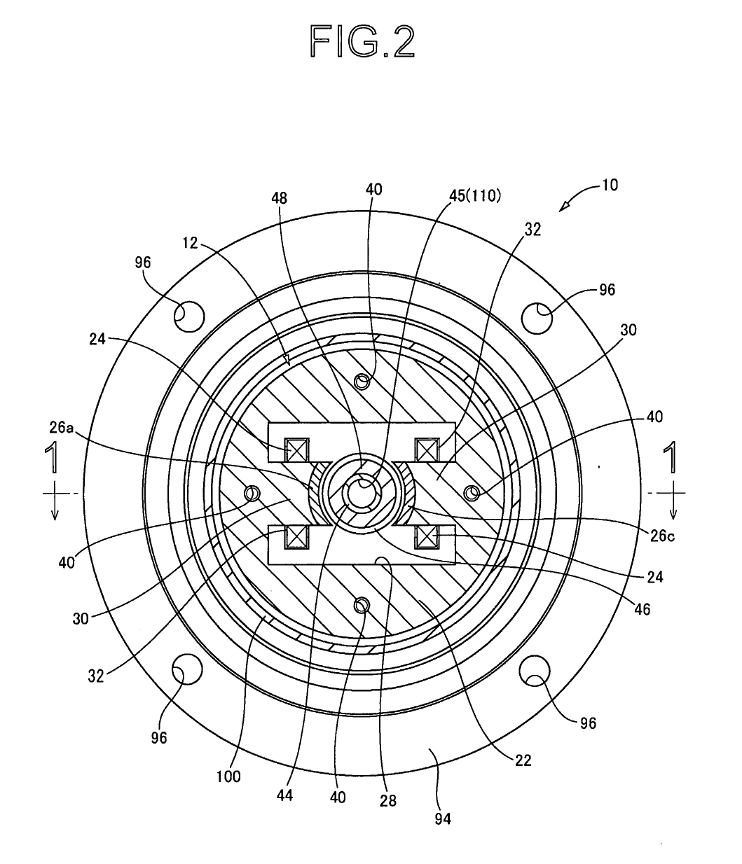

FIGS. 1 and 2 show an active vibration damper 10 of construction according to a first embodiment of the invention. The active vibration damper 10 includes an electric-type linear actuator in the form of an electromagnetic oscillator 12. The electromagnetic oscillator 12 is equipped with a stator 14 and a movable member 16 displaceable relative to the stator 14. The movable member 16 is fixed to a metallic mass member 18 to form a mass member of the active vibration damper 10. Due to oscillation force generated by displacement of the movable member 16 relative to the stator 14, the mass member is oscillated in the axial direction of the active vibration damper 10. A mounting member 20 of metal is fixed to the stator 14 side of the electromagnetic oscillator 12. The mounting member 20 is adapted to be fixed to a target member whose vibration to be damped, e.g. a vehicle body (not shown), whereby the oscillation force of the mass member is applied to the target member so that vibration in the target member is damped in an active or offset fashion. In the following description, a vertical direction shall mean the vertical direction in FIG. 1, which is identical to a driving shaft direction.

Described more specifically, the electromagnetic oscillator 12 has the stator 14 and the movable member 16, and the stator 14 is attached to the target member for a vibration suppression via the mounting member 20. The movable member 16 is displaceable relative to the stator 14.

The stator 14 includes a yoke member 22, coils 24 and 24 wound around the yoke member 22, and four permanent magnets 26a, 26b, 26c, and 26d which adhere to the yoke member 22. As shown in FIGS. 1 and 2, the yoke member 22 is of a thick walled disk shape member having a hollow space 28 at its diametrically central portion, extending therethrough with a generally constant rectangular cross section in its axial direction. A pair of coil wound portions 30, 30 are formed in the yoke member 22 so as to project towards the hollow space 28, and the pair of coil wound portions 30, 30 are positioned to be opposed to each other in one diametric direction, with a given distance therebetween.

In the coil wound portion 30 of the yoke member 22, there are attached the coils 24 of rectangle frame-shape wound around the circumferential direction (the direction of the circumference of a shaft of the coil wound portion 30). In each coil 24, an inner circumferential surface is superposed on the yoke member 22, while the other surface is covered with an insulated cover 32 made of an electrically insulating material. The coil 24 is connected to an external power source (not shown) through a lead wire 34.

The permanent magnets 26a, 26b, 26c, 26d are adhered to the projecting end face of the coil wound portion 30 of the yoke member 22. The permanent magnets 26a, 26b and 26c, 26d are adhered to the projecting distal end face of the pair of coil wound portions 30 and 30, respectively, such that the two permanent magnets 26a, 26b (26c, 26d) are adjacent in the vertical direction on each projecting distal end face of the coil wound portion 30. While the permanent magnets 26a-d are allocated so that each magnetic pole may be formed at opposite sides in the axial direction of the coil wound portion 30, i.e. the axis perpendicular direction which is a projection direction of the coil wound portion 30. The permanent magnet 26a (26c) and the permanent magnet 26b (26d), each pair being allocated mutually adjacent in the vertical direction, are disposed so that the different magnetic poles appear on respective projecting distal end faces of the coil wound portions 30, 30. Further, the permanent magnet 26a (26b) and the permanent magnet 26c (26d), each pair being opposed to each other in the direction of projection of the pair of coil wound portions 30, 30, are disposed so that the different magnetic poles appears on respective projecting end faces. With this arrangement, the permanent magnet 26 generates the magnetic field wherein the magnetic field lines between opposite surfaces of the pair of coil wound portions 30, 30 extend in one way in the axis perpendicular direction in which the pair of coil wound portions 30, 30 are opposed. Further, the magnetic field lines in the magnetic field formed by the upper permanent magnets 26a and 26c and the magnetic field lines in the magnetic field formed by the lower permanent magnets 26b and 26d extend mutually opposite directions in the axis-perpendicular direction. As will be understood from FIG. 2, the projecting end faces of the pair of coil wound portions 30, 30 have a curved concave shape, and the permanent magnets 26a-d have the same curved concave shape along the projecting end faces of the coil wound portions 30, 30.

At the outer peripheral portion of the yoke member 22, an upper fixing bracket 36 and a lower fixing bracket 38 are superposed on each other in the axial direction with the yoke member 22 sandwiched therebetween. The upper fixing bracket 36 is of round tubular shape, and has a shoulder portion on its inner circumferential surface defined between an axially lower small inside-diameter portion and an axially upper large inside-diameter portion. On the other hand, the lower fixing bracket 38 is of round tubular shape, and has a shoulder portion on its inner circumferential surface defined between an axially upper small inside-diameter portion and an axially lower large-inside diameter portion.

These upper fixing bracket 36 and the lower fixing bracket 38 are superposed on each other in the axial direction at the outer peripheral portion of the yoke member 22. A plurality of bolt holes 40, each extending in the axial direction through the mutually superposed upper and lower fixing brackets 36, 38 and the yoke member 22, at respective circumferential positions. By tighten up fixed bolt 42 inserted into the bolt holes 40, the upper fixing bracket 36 and the lower fixing bracket 38 are fixedly attached from an upside and a lower side to the yoke member 22, respectively.

On the other hand, the movable member 16 includes an inner pipe metal member 44 serving as an inner tubular member. The inner pipe metal member 44 has a round tubular shape with a small diameter which extends in the axial direction, whose central hole 45 is linearly prolonged in the axial direction to open at opposite axial ends of the inner pipe metal member 44. A ring shaped magnetic metal member 46 is disposed about and fitted on the inner pipe metal member 44 at an axially central portion of the inner pipe metal member 44. The magnetic metal member 46 is formed of a ferromagnetic material, such as iron, and projects radially outwardly over an entire circumference thereof.

On the axially both sides of the magnetic metal member 46, there are provided an upper pipe metal member 48 and a lower pipe metal member 50. The upper pipe metal member 48 extends straightly in the axial direction with a given length, and disposed about the inner pipe metal member 44 on the axially upper side of the magnetic metal member 46. The lower pipe metal member 50 extends straightly in the axial direction with a given length, and disposed about the inner pipe metal member 44 on the axially lower side of the magnetic metal member 46. In the present embodiment, the inner pipe metal member 44, the upper pipe metal member 48, and the lower pipe metal member 50 are respectively formed of the non-magnetic material.

The stator 14 and movable member 16, each being constructed as described above, are disposed in a co-axial fashion so that the movable member 16 is positioned within a gap between the opposite end faces of the pair of coil wound portions 30, 30 (i.e. radial spacing between the permanent magnets 26a, 26b and the permanent magnets 26c, 26d) with a given radial distance therebetween. Moreover, the permanent magnets 26a-d disposed on the stator 14 and the magnetic metal member 46 disposed on the movable member 16 are opposed to each other in the axis-perpendicular or radial direction with a given radial distance therebetween.

These stators 14 and the movable member 16 are mutually connected by a pair of leaf springs 52, 54 disposed on their upper and lower sides. Each of the pair of upper and lower leaf springs 52, 54 has a generally thin circular disk shape, and is formed with a central hole perforating through its center, which has a circular shape corresponding to the outside diameter of the inner pipe metal member 44. In order to adjust the spring characteristics in the axial direction, each of the leaf springs 52 and 54 has a plurality of perforations (not shown) spirally prolonged from its inner circumferential side toward an outer circumferential side. It should be noted that the central holes of the leaf springs 52, 54 allow communication between areas on axially upper and lower sides of the leaf springs 52, 54.

Outer peripheral edges of the leaf springs 52, 54 are superposed onto the shoulder portions of the upper and lower fixing brackets 36, 38, respectively and fixed to the stator 14 side by means of the fixed bolt 42. On the other hand, inner peripheral edges of the leaf springs 52, 54 are disposed about the inner pipe metal member 44 while being superposed onto and fixed to the upper face of the upper pipe metal member 48 and the lower face of the lower pipe metal member 50, respectively. The inner peripheral edge of the leaf spring 54 is superposed on the top face of the metallic mass member 18 via a spacer ring 53. A press fit fixation ring 55 is press fit onto the inner peripheral edge of the leaf spring 52. With this arrangement, the stator 14 and the movable member 16 are connected together by means of the pair of upper and lower leaf springs 52, 54.

In the active vibration damper 10 of construction as discussed above, the magnetic metal member 46 is located at the axially central portion of the yoke member 22 under the condition of a non-energizing of the coil 24. In other words, if the coil 24 is not energized, a center of the magnetic metal member 46 in the axial direction is positioned to be opposed in the axis-perpendicular direction to a boundary between the axially adjacent upper and lower permanent magnets 26a, 26b (26c, 26d)

When an electric power is supplied through the lead wire 34 to the coil 24, the magnetic field by the magnetic action of a current will occur based on the direction through which a current flows. The generated magnetic fields reinforce the magnetic field formed by one of the upper and lower permanent magnets 26a, 26b, 26c, 26d, while canceling the magnetic field formed by the other of the upper and lower permanent magnets 26a, 26b, 26c, 26d. As a result, the magnetic metal member 46 is attracted by the reinforcing magnetic field formed by the permanent magnets 26a, 26c (26b, 26d) so that the movable member 16 is forced to move one side in the axial direction. The above-described driving principle of this actuator is generally the same as the principle disclosed in JP-A-2005-328685.

The metallic mass member 18 is fixed to the movable member 16. The mass member 18 has a generally thick walled round cylindrical block shape with a center axis extending in the vertical direction. The metallic mass member 18 has a fixation recess 56 open in its upper face. The fixation recess 56 has a hole of a round cylindrical shape, extending with a given depth length with a substantially constant cross sectional shape of small-diameter circle. The inside diameter of the fixation recess 56 is generally the same as or slightly smaller than the outside diameter of the inner pipe metal member 44 of the movable member 16. The axially lower end portion of the inner pipe metal member 44 is forcedly press into the fixation recess 56, so that the metallic mass member 18 is fixedly assembled with the movable member 16. In the present embodiment, the movable member 16 and the metallic mass member 18 cooperate to form a mass member of the present invention, and the total mass of the movable member 16 and the metallic mass member 18 is utilized to generate the desired oscillation force. The mass member (the movable member 16 and the metallic mass member 18) is elastically connected to the target member whose vibration to be damped via a support rubber elastic body 74, and is forced to be oscillated at a frequency corresponding to vibration in the target member, whereby the vibration in the target member is damped in an active or cancellation fashion.

The metallic mass member 18 has a stopper abutting portion 58 of flange shape projecting radially outwardly, which is integrally formed at the axially lower end portion of the metallic mass member 18. Moreover, the metallic mass member 18 has a fixation projection 60 of small-diameter round cylinder shape, integrally formed at its bottom end face so as to project in the axially downward direction. Further, the metallic mass member 18 has a communication hole 62 extending through the center axis of the metallic mass member 18 with a generally constant cross sectional area of small-diameter circle. The upper end of the communication hole 62 is open in the floor face of the fixation recess 56, and the lower end of the communication hole 62 is open in the projecting end face of the fixation projection 60.

To the fixation projection 60 which projects under the metallic mass member 18, there is fixed an inner metal member 64 serving as a movable member side inner member. The inner metal member 64 is a thin-walled hollow cylindrical member having a bottom. An abutting flange 66 is integrally formed at an axially upper open edge of the inner metal member 64. The bottom of the inner metal member 64 has a through hole 68 perforating there through while being located on the center axis of the inner metal member 64. The inner metal member 64 is fixedly mounted onto the fixation projection 60 of the metallic mass member 18 from the axially lower side, so that the inner metal member 64 is coaxially assembled with the metallic mass member 18. The abutting flange 66 of the inner metal member 64 is held in contact with the lower end face of the metallic mass member 18, so that the inner metal member 64 is positioned in the axial direction to the metallic mass member 18. With the inner metal member 64 assembled with the metallic mass member 18, in the present embodiment, a gap is formed between axially opposing lower end face of the metallic mass member 18 and the bottom face of the inner metal member 64. Through this gap, the communication hole 62 of the metallic mass member 18 and the through hole 68 of the inner metal member 64 are held in communication with each other.

An outer pipe member 70 serving as a stator side outer cylinder member is disposed radially outward of the inner metal member 64 with a given radial spacing therebetween, in a co-axial fashion. The outer pipe member 70 has a thin-walled large-diameter cylindrical shape overall, with its axially upper end bent to a radially inner side and with its axially lower end bent to a radially outer side to form a holding part 72. In the present embodiment, the outer pipe member 70 is located slightly below the inner metal member 64 in the axial direction.

Between the opposite surfaces of the inner metal member 64 and the outer pipe member 70, there is disposed the support rubber elastic body 74 serving as an elastic connecting rubber. The support rubber elastic body 74 has a ring plate shape as a whole, whose thickness is gradually small toward the outer peripheral side, in the present embodiment. The inner circumferential surface of the support rubber elastic body 74 is bonded by vulcanization to the outer circumferential surface of the inner metal member 64, and the lower face of the abutting flange 66, while the outer circumferential surface is the bonded by vulcanization to the inner circumferential surface of the outer pipe member 70. With this arrangement, the inner metal member 64 (the metallic mass member 18 and the movable member 16) and the outer pipe member 70 (stator 14), which isolates in an axis perpendicular direction only prescribed distance, are elastically connected together by the support rubber elastic body 74. In the present embodiment, a cylindrical bound stopper rubber 76 is integrally formed on the lower end of the inner peripheral part of the support rubber elastic body 74. The bound stopper rubber 76 is bonded by vulcanization to the outer peripheral portion of the bottom wall portion of the inner metal member 64 so as to projects axially downwardly. The central portion of the bottom wall portion of the inner metal member 64 is exposed to the axially lower side through the central bore of the bound stopper rubber 76, and the through hole 68 formed in the center of the bottom wall portion of the inner metal member 64 is open to the axially lower side through the central hole of the bound stopper rubber 76.

The outer pipe member 70 is attached to the mounting member 20. This mounting member 20 is composed of a cylindrical cover metal member 78 and a bottom plate member 80. The cylindrical cover metal member 78 is a round tubular shape overall with several stepped portions by which the diameter at its axially lower end is greater than that at its axially upper end. The outer pipe member 70 is press fit into the cylindrical cover metal member 78 from the axially lower side, so that a holding part 72 of the outer pipe member 70 is held in contact with one of the stepped portions of the cylindrical cover metal member 78 from the axially lower side, whereby the outer pipe member 70 is positioned in the axial direction with respect to the cylindrical cover metal member 78.

At the axially upper end portion of the cylindrical cover metal member 78, a stopper support portion 82 of the shape of an inner flange is integrally formed so as to project radially inwardly. The stopper support portion 82 is located axially above the stopper abutting portion 58 of the metallic mass member 18 with a given axial spacing therebetween. On the upper face of the stopper support portion 82, the lower fixing bracket 38 of the electromagnetic oscillator 12 is superposed from the axially upper side, so that the stator 14 is disposed on the cylindrical cover metal member 78 (mounting member 20). With this arrangement, the electromagnetic oscillator 12 is disposed axially upward of the support rubber elastic body 74.

A generally ring shaped stopper member 84 is press fit into the upper end portion of the cylindrical cover metal member 78. This stopper member 84 includes a fixing bracket 86 and a rebound stopper rubber 88. The fixing bracket 86 has a peripheral wall portion of round tubular shape, and a rubber adherence part 90 having an inner flange shape, projecting radially inwardly from the upper end of the peripheral wall portion. The rebound stopper rubber 88 of ring shape continuously extending in the circumferential direction with a generally constant rectangular cross sectional shape is bonded on the lower face of the rubber adherence part 90 so as to project axially downwardly therefrom. With the stopper member 84 attached to the cylindrical cover metal member 78, as shown in FIG. 1, a given gap is formed between axially opposite lower end face of a rebound stopper rubber 88 and the stopper abutting portion 58 of the metallic mass member 18. When the metallic mass member 18 (inner metal member 64) is displaced excessively in the axially upward direction relative to the cylindrical cover metal member 78 (outer pipe member 70), the stopper abutting portion 58 is brought into abutting contact with the stopper support portion 82 via the rebound stopper rubber 88, thereby providing a rebound stopper mechanism for limiting an amount of displacement of the inner metal member 64 (movable member 16) relative to the outer pipe member 70 (stator 14) in the rebound direction or in the axially upward direction.

The bottom plate member 80 is of inverted generally shallow disk shape, and has a shoulder portion at its axially intermediate portion. The top wall of the bottom plate member 80 is projected axially upwardly at its radially central portion so as to form a recess open toward the lower side.

The bottom plate member 80 is press fit into the cylindrical cover metal member 78 from the axially lower open end thereof. In the present embodiment, the stepped portions formed on the peripheral wall of the bottom plate member 80 and the stepped portions formed on the peripheral wall of the cylindrical cover metal member 78 are superposed on one another in the axial direction, whereby the cylindrical cover metal member 78 and the bottom plate member 80 are relatively positioned in the axial direction. Moreover, a sealing rubber 92 is provided between axially superposed stepped portions of the cylindrical cover metal member 78 and the bottom plate member 80, thereby ensuring a fluid-tight sealing at superposed stepped portions.

The holding part 72 formed in the lower edge of the outer pipe member 70 is brought into contact with the outer peripheral portion of the top wall of the bottom plate member 80 from the axially upper part, and the holding part 72 of the outer pipe member 70 is gripped by and supported between the stepped portion of the cylindrical cover metal member 78, and the upper bottom wall portion of the bottom plate member 80 in the axial direction.

In the present embodiment, with the active vibration damper 10 assembled as described above, the inner metal member 64 is arranged so as to be spaced above the top wall of the bottom plate member 80, and the bound stopper rubber 76, which is bonded to the lower face of the bottom wall portion of the inner metal member 64, is spaced away from the top wall of the bottom plate member 80 in the axially upward direction by a given distance. When the inner metal member 64 is forced to move excessively toward the bottom plate member 80 (outer pipe member 70) in the axial direction, the bottom of the inner metal member 64 is brought into contact with the top wall of the bottom plate member 80 via the bound stopper rubber 76, thereby providing a bound stopper mechanism wherein the amount of displacement of the inner metal member 64 (movable member 16) relative to the outer pipe member 70 (stator 14) is limited. In this embodiment, the separation of the bound stopper rubber 76 and the top wall of the bottom plate member 80 is suitably adjusted by bending the center portion of the top wall of the bottom plate member 80 so as to project upwardly.

In addition, an attachment flange 94 is integrally formed at the lower open edge portion of the bottom plate member 80 so as to extend in the axis-perpendicular direction. As shown in FIG. 2, the attachment flange 94 has bolt holes 96 formed at a plurality of circumferential positions, and fixed to the target member whose vibration to be damped, such as a vehicle body (not shown), by means of mounting bolts (not shown) inserted into the bolt holes 96. With this arrangement, the stator 14 attached to the cylindrical cover metal member 78 is fixedly attached to the target member for a vibration damping through the bottom plate member 80.

A cap member 100 is disposed above the cylindrical cover metal member 78. The cap member 100 has a generally inverted cylindrical cup shape overall, and is disposed so as to surround the axially upper part and radially outer part of the electromagnetic oscillator 12 substantially entirely. Moreover, the lower opening of the cap member 100 is press fit onto the upper end portion of the cylindrical cover metal member 78. The stepped portion formed on the lower end portion of the cap member 100 and the stepped portion formed on the upper end portion of the cylindrical cover metal member 78 are brought into contact with each other in the axial direction, whereby the cap member 100 and the cylindrical cover metal member 78 are assembled and mutually positioned in the axial direction. In the present embodiment, a sealing rubber 102 of ring shape is provided and gripped between axially superposed stepped portions of the cylindrical cover metal member 78 and the cap member 100, thereby ensuring a fluid-tight sealing at superposed stepped portions. The lead wire 34 connected to the coil 24 is prolonged outside through the penetration hole formed by penetrating the peripheral wall portion of the cap member 100. With the lead wire 34 being inserted, the penetration hole is sealed by filling up a sealant.

The peripheral edge of the upper bottom wall portion of the cap member 100 is superposed on the outer peripheral portion of the upper fixing bracket 36 from the axially upper side. The upper fixing bracket 36, the yoke member 22 and the lower fixing bracket 38, which are mutually superposed in the axial direction, are gripped and positioned between axially opposite faces of the stopper support portion 82 formed in the upper end of the cylindrical cover metal member 78, and the top wall of the cap member 100. With this arrangement, the stator 14 of the electromagnetic oscillator 12 is fixed to the mounting member 20, and the stator 14 is attached to the target member for a vibration damping via the mounting member 20.

In the active vibration damper 10 of construction as discussed above, the axially upper open end of the cylindrical cover metal member 78 is fluid-tightly closed by means of the cap member 100, while the axially lower open end is fluid-tightly closed by means of the bottom plate member 80. Thus, between the opposite surfaces of the cap member 100 and the bottom plate member 80, there is formed a hermetic air chamber 104 sealed by the cylindrical cover metal member 78, the bottom plate member 80, and the cap member 100 from exterior space. As will be apparent from the above description, the cylindrical cover metal member 78 cooperates with the cap member 100 and the bottom plate member 80, which has been fluid-tightly assembled to the cylindrical cover metal member 78, to form a cover member in the present embodiment. Also, the bottom plate member 80 constitutes the mounting member adapted to be fixed to the target member whose vibration to be damped. With this arrangement, the cover member and the mounting member are integrally formed in the present embodiment.

The electromagnetic oscillator 12 is housed within the hermetic air chamber 104. By connecting the inner metal member 64 attached to the metallic mass member 18 (movable member 16), and the outer pipe member 70 disposed within the cylindrical cover metal member 78 (stator 14) by the support rubber elastic body 74 which spreads in an axis perpendicular direction, the hermetic air chamber 104 is divided into axially opposite sides of the support rubber elastic body 74. Namely, on the axially upper side of the support rubber elastic body 74, there is formed a first air chamber 106 which spreads between axially opposite surfaces of the cap member 100 and the support rubber elastic body 74, and which houses the electromagnetic oscillator 12 and the metallic mass member 18 therein. On the axially lower side of the support rubber elastic body 74, there is formed a second air chamber 108 which spreads between axially opposite surfaces of the support rubber elastic body 74 and the bottom plate member 80.

As will be apparent from FIG. 1, the air channel 110 is formed so as to extend along the center-axis of the electromagnetic oscillator 12. This air channel 110 permits a communication between the first air chamber 106 and the second air chamber 108 which are formed axially opposite sides of the support rubber elastic body 74. In the present embodiment, the central hole 45 of the inner pipe metal member 44, the communication hole 62 penetrating through the metallic mass member 18, and the through hole 68 formed in the bottom wall portion of the inner metal member 64 are mutually connected in the axial direction, whereby the air channel 110 is formed so as to extend straightly in the axial direction. One opening of the central hole 45 of the inner pipe metal member 44 is held in communication with the first air chamber 106, whereby the one opening of the air channel 110 is held in communication with the first air chamber 106. The through hole 68 is open to the second air chamber 108, whereby the other opening of the air channel 110 is held in communication with the second air chamber 108. In the present embodiment, since the support rubber elastic body 74 has a generally round disk plate shape and is bonded to the bottom wall portion of the inner metal member 64 except the central portion, the through hole 68 formed through the bottom wall portion of the inner metal member 64 is able to be connected to the second air chamber 108.

In the active vibration damper 10 of construction according to the present embodiment, when electric power is supplied to the coil 24 to operate the electromagnetic oscillator 12, a resultant heat will generated in the first air chamber 106 in which the electromagnetic oscillator 12 containing the coil 24 is accommodated. This first air chamber 106 is air tightly closed from the exterior space, as stated above.

Due to the heat generated by the electromagnetic oscillator 12, the room temperature in the first air chamber 106 will rise gradually. This causes the difference in room temperature between the first air chamber 106 which has accommodated the heating element (electromagnetic oscillator 12), and the second air chamber 108 which has not accommodated the heating element. As a result, this room temperature difference will cause the interior pressure difference between the first air chamber 106 and the second air chamber 108. That is, in the first air chamber 106 in which temperature rises easily with a heating element, the air sealed indoors will expand, so that an indoor pressure rises easily. Thus, the pressure in the first air chamber 106 is likely to become high as compared with the pressure of the second air chamber 108.

With this regards, the present active vibration damper 10 permits air flows between the first air chamber 106 and the second air chamber 108 via the air channel 110 prolonged along its centre axis. Therefore, once a pressure differential arises between the first air chamber 106 and the second air chamber 108 which are formed on axially opposite sides of the support rubber elastic body 74, indoor air is made to flow through the air channel 110 based on the pressure differential between both air chambers 106, 108. As a result, the pressure differential produced between the first air chamber 106 and the second air chamber 108 is promptly cancelable. This arrangement makes it possible to prevent elastic deformation so that the support rubber elastic body 74 may bulge in a low tension side (second air chamber 108 side) from a high tension side (first air chamber 106 side) according to the pressure differential between both air chambers 106, 108. Therefore, it is possible to maintain with high precision the relative position between the stator 14 and the movable member 16 under the condition to the coil 24 of not energizing (i.e., the axis-perpendicular spacing between the stator 14 and the movable member 16, or the axial position of the movable member relative to the stator under the condition of not energizing of the coil 24). Thus, the present active vibration damper 10 is able to obtain desired oscillation force, thereby effectively exhibiting excellent vibration damping performance. Further, since the variation in spring constant in the axial direction due to the elastic deformation of the support rubber elastic body 74 can be avoided, whereby the active vibration damper 10 is able to exhibit oscillation force with high precision, and desired damping effect with stability.

In addition, the pressure differential between both chambers 106, 108 is canceled by connecting through the air channel 110 between the first air chamber 106 and the second air chamber 108 which are located in the sealed hermetic air chamber 104 from exterior space at the both sides of the support rubber elastic body 74. This makes it possible to cancel the pressure differential between both chambers 106, 108, while avoiding completely entry of debris, such as water and a particulate, into the hermetic air chamber 104 from exterior space, thereby attaining both of the durability of the electromagnetic oscillator 12, and the outstanding damping effect as a result of stable output of the electromagnetic oscillator 12. It should be noted that in the linear actuator (electromagnetic oscillator 12) of an electric type, the gap between the stator 14 and the movable member 16 is set up very small in order to obtain oscillating force efficiently. Thus, once debris, such as dust from the outside, enters into the minute gap between these stators 14 and the movable member 16, there is a possibility that smooth oscillation motion of the movable member 16 may be barred. In this respect, the active vibration damper 10 of the present embodiment will prevent thoroughly trespass of the debris from the outside to the gap between a stator 14 and the movable member 16. This makes it possible to make small enough the gap between a stator 14 and the movable member 16, whereby oscillating force can be obtained with high efficiency, and can be generated with stability owing to smooth actuation of the movable member 16 to the stator 14.

Moreover, since the first and second air chambers 106, 108, which are formed on both sides of the support rubber elastic body 74, are held in communication with each other through the air channel 110, when the movable member 16 is displaced in the axial direction by means of the energized coil 24, the movable member 16 is prevented from being affected by an air spring acting between the first air chamber 106 and the second air chamber 108 accompanying an actuation variation rate. Thus, the active vibration damper 10 is able to exhibit high precise operation.

Moreover, since the wall portion of the air channel 110 is constituted by the inner pipe metal member 44 and the metallic mass member 18 which are made of a rigid material, the passage sectional area of the air channel 110 can be obtained by being stabilized, thereby readily realizing dissolution of the pressure differential by air flows between the first air chamber 106 and the second air chamber 108. Thus, the active vibration damper 10 is able to exhibit desired damping effect with efficiency.

In the electromagnetic oscillator 12 of a type wherein the movable member 16 is located in the inner circumference side of the stator 14, the air channel 110 is formed so as to extend on the center axis of the electromagnetic oscillator 12. Thus, the air channel 110 can be formed with high space utilization in comparison with the case where a special air passage is formed on the outer circumference side. This makes it possible to effectively downsize the active vibration damper 10.

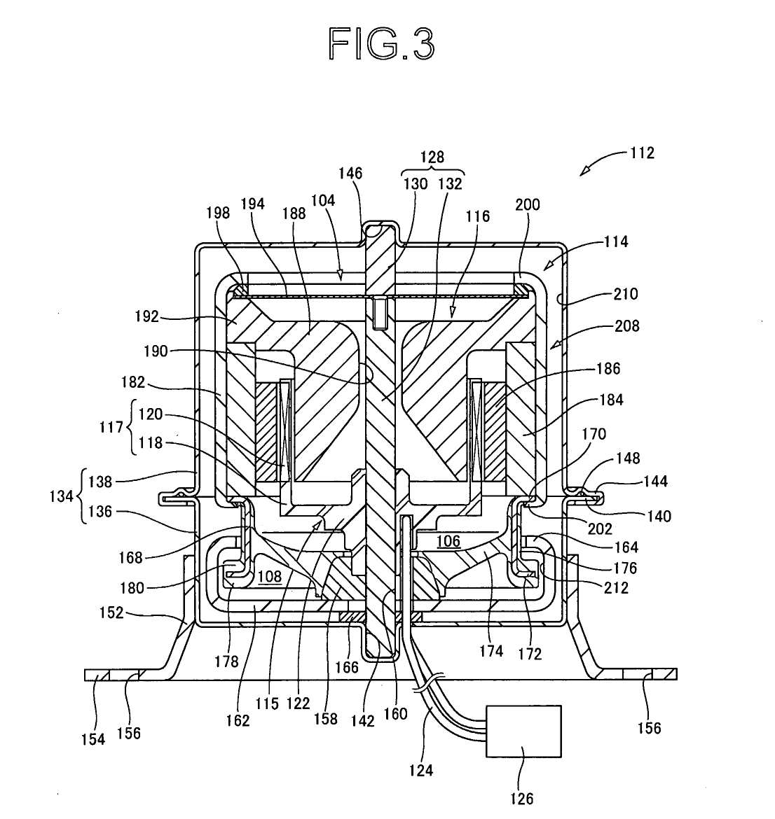

Referring next to FIG. 3, there is shown an active vibration damper 112 of construction according to a second embodiment of the present invention. This active vibration damper 112 includes an electromagnetic oscillator 114 as an electric-type linear actuator. In the following description, a vertical direction shall mean the vertical direction in FIG. 3, which is identical to a driving shaft direction.

More specifically, the electromagnetic oscillator 114 includes a stator 115 attached to the target member for a vibration damping (not shown), and a movable member 116 actively displaceable relative to the stator 115.

The stator 115 has a coil component 117. The coil member includes a bobbin 118 and a coil 120 wound around the bobbin 118. The bobbin 118 is made of a non-magnetic material, such as a hard synthetic resin material, and has a generally round tubular shape with a bottom overall. The bobbin 118 has a circumferential groove open in an outer circumferential surface of its peripheral wall portion, so that the coil 120 is accommodated within the groove while being wound around the bobbin 118. A fixed tube member 122 is integrally formed at the center of the bottom wall portion of the bobbin 118 so as to project in the axially upper and lower sides. The fixed tube member 122 has a bore extending therethrough in the axial direction. The coil 120 is connected to an external power supply 126 by a lead wire 124.

An axial metal member 128 as a fixed shaft member is inserted through the fixed tube member 122 of the bobbin 118, and is fixed to the fixed tube member 122. The axial metal member 128 has a rod shaped prolonged linearly in the axial direction, and is constituted by connecting in the axial direction upper and lower rod metal members 130, 132 formed of a non-magnetic material.

Axially both ends of the axial metal member 128 are fixed to a case metal member 134 serving as a cover member. The case metal member 134 is composed of a bottom metal member 136 and a cap member 138 which are put together vertically. The bottom metal member 136 has a thin-walled large-diameter cylindrical cup shape overall, and includes a flange part 140 integrally formed at its open peripheral edge so as to spreads outward in the axis-perpendicular direction. A lower fixation recess 142 is formed at radially central portion of the bottom metal member 136, which is bent in shape of small-diameter round tubular recess. On the other hand, the cap member 138 has an inverted thin-walled large-diameter cylindrical cup shape overall, with a diameter dimension identical with that of the bottom metal member 136. A caulking edge 144 is integrally formed at the open peripheral edge of the cap member 138 so as to spread outwardly in the axis-perpendicular direction. An upper fixation recess 146 is formed at radially central portion of the top wall portion of the cap member 138, which is bent in shape of small-diameter round tubular recess.

The axially both ends of the axial metal member 128 is press fit into the lower fixation recess 142 of the bottom metal member 136 and the upper fixation recess 146 of the cap member 138, respectively. Each opening of the bottom metal member 136 and the cap member 138 are mated together in the axial direction, and the flange part 140 of the bottom metal member 136 is caulked by the caulking edge 144 of the cap member 138. As a result, the bottom metal member 136 and the cap member 138 are fixedly assembled mutually. Further, a ring shape seal rubber 148 is compressed between superposed surfaces of the flange part 140 and the caulking edge 144, thereby providing a fluid-tight sealing between the bottom metal member 136 and the cap member 138. Thus, a hermetic air chamber 104 is formed between the inside area of the bottom metal member 136 and the cap member 138, which is air-tightly sealed from the exterior space. In the present embodiment, the lead wire 124 connected to the coil 120 is prolonged outside through the penetration hole which penetrates the bottom wall portion of the bottom metal member 136. Like the penetration hole in the first embodiment, this penetration hole is sealed by filling up a sealant with the lead wire 124 being inserted.

To the bottom metal member 136, there is fixed a mounting leg 152 serving as a mounting member. The mounting leg 152 has a generally round cylindrical shape overall. The axially upper part of the mounting leg 152 is disposed about and fixed onto the bottom metal member 136, while the axially lower part of the mounting leg 152 is prolonged below rather than the bottom metal member 136. A mounting flange 154 is formed at the axially lower end portion of the mounting leg 152, so as to spread outwardly in the axis perpendicular direction. The mounting flange 154 has bolt holes 156 formed at a plurality of circumferential positions, and fixed to the target member whose vibration to be damped, such as a vehicle body (not shown), by means of mounting bolts (not shown) inserted into the bolt holes 156. As will be understood from the above description, the stator 115 in the present embodiment is composed of the respective components fixed to the case metal member 134 (i.e. the coil component 117, the axial metal member 128, the inner metal member 158 mentioned later, the stopper member 162 mentioned later, or the like).

An inner metal member 158 serving as a stator side inner member is attached to the axial metal member 128. The inner metal member 158 is of generally circular block shape, and has a through hole 160 perforating therethrough in the axial direction at its radially central portion. The through hole 160 is a stepped round bore having a large-diameter axially upper portion and a small-diameter axially lower portion. The axial metal member 128 is inserted into the small-diameter axially lower portion of the through hole 160 of the inner metal member 158, while the lower end portion of the fixed tube member 122 in the bobbin 118 is inserted into the large-diameter axially upper portion of the through hole 160.

A stopper member 162 is superposed on and attached to the underside of the inner metal member 158. The stopper member 162 is formed of a nonmagnetic material of high rigidity, and has a generally shallow disk shape. The open peripheral edge of the stopper member 162 is bent radially inwardly to form an abutting portion 164 projecting inward in the axis-perpendicular direction. The stopper member 162 further includes a central hole axially perforating the radially central portion of its bottom wall portion, into which central hole, the axial metal member 128 is inserted. A spacer metal member 166 is disposed between the opposite surfaces of the bottom wall portion of the stopper member 162 and the bottom wall portion of the bottom metal member 136. This spacer metal member 166 is of a ring plate shape, and is externally fitted onto the axial metal member 128, while being superposed at its axially both surfaces on the lower face of the bottom wall portion of the stopper member 162 and the upper face of the bottom wall portion of the bottom metal member 136.

The movable member 116 includes an outer pipe member 168 serving as a movable member side outer cylinder member. The outer pipe member 168 is a generally thin annular member having a diameter larger than that of the inner metal member 158 while smaller than that of the stopper member 162. The outer pipe member 168 is disposed coaxially with the inner metal member 158 and the stopper member 162, and extends between peripheral wall portions of the inner metal member 158 and the stopper member 162, while being spaced from the inner metal member 158 and the stopper member 162 in the axis-perpendicular direction. At the axially upper end portion and the lower end portion of the outer pipe member 168, there is integrally formed a fixed flange 170 and a stopper abutting portion 172 bending outwardly in the axis-perpendicular direction. The stopper abutting portion 172 of the outer pipe member 168 is located between the axially opposite surfaces of the peripheral edge portion of the peripheral wall of the stopper member 162 and the abutting portion 164, with a given axial distance from the peripheral wall of the stopper member 162 and the abutting portion 164.

Between the opposite surfaces of the inner metal member 158 and the outer pipe member 168, there is provided a support rubber elastic body 174 serving as an elastic connecting rubber. The support rubber elastic body 174 has a ring plate shape. An inner circumferential surface of the support rubber elastic body 174 is bonded by vulcanization to the outer circumferential surface and top-face peripheral edge of the inner metal member 158. An outer circumferential surface of the support rubber elastic body 174 is bonded by vulcanization to the inner circumferential surface of the outer pipe member 168. In the present embodiment, the inner metal member 158 is located slightly below the outer pipe member 168 in the axial direction, so that the support rubber elastic body 174 has a shape of a concave which inclines gently to the lower side as it goes to the center side. With this arrangement, the stator 115 and the movable member 116 are elastically connected by the support rubber elastic body 174.

In the present embodiment, the inner and outer circumferential surfaces of the outer pipe member 168 are covered over the generally entire area by a covering rubber layer 176, and the covering rubber layer 176 is integrally formed with the support rubber elastic body 174. That is, the generally entire peripheral wall portion of the outer pipe member 168 is covered with the covering rubber layer 176.

On the bottom face and top face of the stopper abutting portion 172 of the outer pipe member 168, there are bonded a bound stopper rubber 178 and a rebound stopper rubber 180 respectively, which have a wall thickness greater than the covering rubber layer 176. These bound stopper rubber 178 and rebound stopper rubber 180 are integrally formed with the covering rubber layer 176 and the support rubber elastic body 174. If the outer pipe member 168 is displaced excessively in the axial direction relative to the inner metal member 158, the stopper abutting portion 172 of the outer pipe member 168 comes into contact with the bottom wall peripheral edge and the abutting portion 164 of the stopper member 162 via the bound stopper rubber 178 and the rebound stopper rubber 180, respectively in both axial sides. Thus, there is provided a bound stopper mechanism and a rebound stopper mechanism for limiting an amount of displacement of the outer pipe member 168 relative to the inner metal member 158 in the axially opposite directions.

The outer pipe member 168 is attached to a cylindrical housing 182. The cylindrical housing 182 has a round tubular shape with a diameter slightly greater than that of the outer pipe member 168. A thick-walled cylindrical mass member 184 is affixed to the inner circumferential surface of the cylindrical housing 182 at its axially medial portion. The mass member 184 is formed of a ferromagnetic material, and is disposed co-axially with the cylindrical housing 182.

Onto the inner circumferential surface of the mass member 184, a permanent magnet 186 is superposed and fixed. The permanent magnet 186 has a round tubular shape, and is fixed to the axially intermediate portion of the mass member 184. The magnetic pole is formed on opposite surfaces of the permanent magnet 186 in the axis-perpendicular direction.

In the inner circumference side of the permanent magnet 186, a yoke member 188 of metal is disposed with a given distance therebetween. The yoke member 188 has a circular block shape overall. The yoke member 188 has a through hole 190 extending therethrough in the axial direction at its radially intermediate portion. The through hole 190 has an inside diameter that is made small at its axially intermediate portion, and gradually increases towards its lower axial end, while gradually increases towards its upper axial end to form a circular cavity. The axial metal member 128 is inserted into the through hole 190 loosely. A fixation portion 192 is integrally formed at the upper end portion of the yoke member 188 so as to project outwardly in the axis-perpendicular direction. The fixation portion 192 has a generally ring plate shape, and is held in contact at its outer circumferential surface with the inner circumferential surface of the cylindrical housing 182, while is superposed at its bottom face of the outer peripheral portion on the upper end face of the mass member 184.

A leaf spring 194 is disposed above the yoke member 188. The leaf spring 194 is a thin disk member having a central hole penetrating its radially center portion. Like the leaf springs 52, 54 in the first embodiment, the leaf spring 194 has a plurality of perforations spirally prolonged from its inner circumferential side toward an outer circumferential side, in order to adjust the spring characteristics in the axial direction. The perforations of the leaf spring 194 allow communication between areas on axially upper and lower sides of the leaf spring 194. The outer peripheral edge of the leaf spring 194 is superposed on the top face of the fixation portion 192 of the yoke member 188, and the inner periphery of the leaf spring 194 is fixed to the axial metal member 128. Further, a ring-shaped abutting member 198 puts on the peripheral edge of the leaf spring 194, so that the peripheral edge of the leaf spring 194 is gripped between the yoke member 188 and the abutting member 198 in the axial direction. The inner periphery of the leaf spring 194 is gripped between the combination parts of the upper rod metal member 130 and the lower rod metal member 132 which constitute the axial metal member 128. The combination bolt which projects from the upper rod metal member 130 is inserted into the central hole of the leaf spring, and then is screwed on the bolt hole formed in the upper end face of the lower rod metal member 132, whereby the inner periphery of the leaf spring 194 is fixed to the axial metal member 128.

The cylindrical housing 182 has an inward projection 200 and a caulking part 202 integrally formed at its axially upper and lower ends, which are bent radially inwardly. Between the axially opposite faces of the inward projection 200 and the caulking part 202, there are forcedly gripped or supported the fixed flange 170 of the outer pipe member 168, the mass member 184, the fixation portion 192 of the yoke member 188, the leaf spring 194, and the abutting member 198, which are axially superposed on one another in this order. With this arrangement, the movable member 116 displaceable relative to the stator 115 is composed of the outer pipe member 168, the yoke member 188, the permanent magnet 186, and the mass member 184. In the present embodiment, the mass member is constituted integrally with the movable member 116, while including the mass member 184, the yoke member 188, and the permanent magnet 186. The movable member 116 needing a given mass is forced to displaced, thereby exhibiting a desired oscillation force. As will be understood from the above description, the inner metal member 158 is attached to the stator 115 side, and the outer pipe member 168 is attached to the movable member 116 side. By connecting these inner metal member 158 and the outer pipe member 168 elastically by the support rubber elastic body 174, the stator 115 and the movable member 116 is mutually connected elastically by the support rubber elastic body 174.

In the electromagnetic oscillator 114 constituted by assembling the stator 115 and the movable member 116, the coil 120 of the stator 115 is disposed within a gap between opposite surfaces of the yoke member 188 of the movable member 116 and the permanent magnet 186, in a non energizing state of the coil 120. Note that the coil 120 is disposed to be isolated from both the yoke member 188 and the permanent magnet 186.

When an electric power is supplied to the coil 120 from the external power supply 126, a force is generated by the current flowing through the magnetic field formed by the permanent magnet 186. By means of this generated force, the movable member 116 is forced to move relative to the stator 115 toward one axial side. The direction of the generated force is determined according to the direction of the current which flows through the coil 120 as well as the direction of the magnetic poles of the permanent magnet 186. Therefore, in the case where the permanent magnet 186 is disposed fixed and it is provided that the current energized in the coil 120 is considered as Alternating Current, the movable member 116 can be displaced on both sides in the axial direction by alternately change the direction of the current in right/reverse directions applied to the coil 120. Therefore, the desired oscillation force can be obtained by applying to the coil 120 the Alternating Current controlled according to a frequency of vibration in the target member, or alternatively by executing an ON/OFF control of energizing of the coil 120.

By applying the controlled alternating current or pulsating current to the coil 120, or alternatively by controlling ON/OFF of energizing of the coil 120, the movable member 116 integrally equipped with the mass member is displaced or oscillated in the axial direction, thereby exhibiting desired oscillation force. As a result, the active vibration damper 112 is able to apply the desired oscillating force on the target member for a vibration damping, thereby damping vibration excited in the target member in an active or cancellation fashion.

In the active vibration damper 112 of construction according to the present embodiment, the bottom metal member 136 having a generally round tubular cup shape, and the cap member 138 having an inverted generally round tubular cup shape are fluid-tightly assembled together with the seal rubber 148 interposed therebetween. Thus, a hermetic air chamber 104 air tightly closed from the exterior space is formed between the bottom metal member 136 and the cap member 138.

By connecting the inner metal member 158 and the outer pipe member 168 with the support rubber elastic body 174, the hermetic air chamber 104 is divided into a first air chamber 106, which is located on the axially upside of the support rubber elastic body 174 and houses the electromagnetic oscillator 114 having the coil 120, and a second air chamber 108 located on the axially lower side of the support rubber elastic body 174.

In the active vibration damper 112 of construction according to the present embodiment, the first air chamber 106 and the second air chamber 108 are mutually communicated via an air channel 208. More specifically, the air channel 208 is formed by using a gap 210 formed between the opposite surfaces of the cylindrical housing 182 (movable member 116) and the case metal member 134, and a gap 212 formed between the opposite surfaces of the outer pipe member 168 (movable member 116) and the stopper member 162. Those gaps 210, 212 are mutually connected, thereby providing the air channel 208 for permitting mutual communication between the first air chamber 106 and the second air chamber 108.

In the active vibration damper 112 of construction according to the present embodiment, like in the first embodiment, the pressure differential based on the relative temperature difference of the first air chamber 106 housing the heating element, like the coil 120, and the second air chamber 108 is canceled as soon as possible by air flows through the air channel 208. This makes it possible to prevent unpleasant deformation of the support rubber elastic body 174 due to pressure differential between both chambers 106, 108, and a resultant failure in exhibiting desired oscillation force. Thus, the active vibration damper 112 is able to exhibit desired damping effect advantageously.

In the present embodiment, the outer pipe member 168 is connected to the movable member 116 in the employed electromagnetic oscillator 114. Thus, the gaps 210, 212 for actuation of the movable member 116 is formed between the radially opposite case metal member 134 and cylindrical housing 182. In the present embodiment, the air channel 208 is formed effectively utilizing the gaps 210, 212 prepared in order to realize actuation of the movable member, so that the active vibration damper 112 equipped with the air channel 208 is realized with sufficient space utilization. Therefore, the active vibration damper 112 which demonstrates the outstanding damping effect by forming the air channel 208 can be realized with compact size.

While the present invention has been described in detail in its presently preferred embodiment, for illustrative purpose only, it is to be understood that the invention is by no means limited to the details of the illustrated embodiment, but may be otherwise embodied.

For example, a variety of known electric-type linear actuators would be employed, but not limited to the electric-type linear actuator of the configuration same as the electromagnetic oscillators 12, 114 shown in the first and second embodiments.

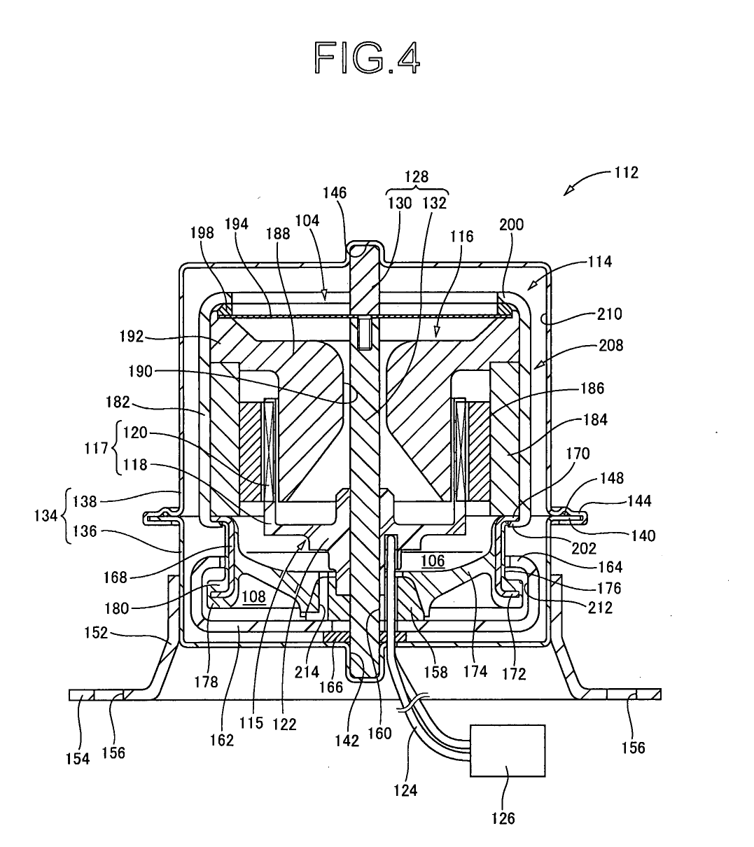

While in the active vibration dampers 10, 112 shown in the first and second embodiments only one air channel is formed, two or more air channels may be formed in one active vibration damper. More specifically, it is possible to employ both of the channel formed through the inner member, and the air channel formed between the outer cylinder member and the cover member. In the case where the inner member side is used as the movable member like in the first embodiment, an air channel may be formed so as to extend between the stator and the cover members. As shown in FIG. 4 where the outer pipe member 168 adopts the electromagnetic oscillator 114 attached to the movable member 116 side, like in the second embodiment, the air channel 215 extending in the radially inner side of the electromagnetic oscillator 114, may be formed by utilizing a through hole 214 extending through the stator 115 side, for example, the inner metal member 158 and the support rubber elastic body 174 in FIG. 4.

The air channel does not necessarily need to be formed using the gap between the opposite surfaces of the through hole or outer cylinder member, which are formed in the inner member, and the cover member. Specifically, it is also possible to form an air channel in the elastic connecting rubber, for example. Namely, the elastic connecting rubber may be composed of an annular inside rubber bonded to the inner member, and an annular outside rubber having a diameter larger than that of the inside rubber while being coaxially disposed with the inside rubber. The inside and outside rubbers are mutually connected together by means of a plurality of radially extending connecting parts mutually spaced away from each other in the circumferential direction. The circumferential gaps between the adjacent connecting parts may be utilized as the air channel.

As will be understood from the second embodiment, the air channel may have a variety of cross sectional shape (hole shape), without specific limitation. The air channel does not need to extend with the constant cross sectional shape. Furthermore, suitably, although the air channel is formed of the hard component, such as metal etc., for example, it can also be formed by elastic components, such as a rubber hose.

In the first and second embodiments illustrated above, the pressure differential produced based on the temperature gap by the heating element (electric-type linear actuator) housed within the first air chamber 106 is canceled by air flows through the air channel. In addition, the pressure differential produced based on the temperature gap between the first and second air chambers 106, 108 due to an external environment etc. can be also canceled effectively.

The mounting means for mounting the inner and outer members fixed to the stator side on the target member for a vibration damping (i.e. the cover member) may have a variety of construction without limiting to those shown in the first and second embodiments.

It is also to be understood that the present invention may be embodied with various other changes, modifications and improvements, which may occur to those skilled in the art, without departing from the spirit and scope of the invention defined in the following claims.

What is claimed is:

1. An active vibration damper comprising:
an electric-type linear actuator including a stator, a movable member disposed displaceable relative to the stator; and a coil arranged in one of the stator and the movable member, the coil being energized to generate a magnetic field that exerts a force on the movable member to drive the movable member relative to the stator;
a mounting member to which the stator of the linear actuator is fixed;
a mass member constituted by incorporating the movable member of the linear actuator;
an elastic connecting rubber connecting the mass member to the stator, and being disposed such that the linear actuator is disposed on one side of the elastic connecting rubber in a direction of displacement of the movable member relative to the stator so that the mass member is oscillated by means of driving force applied to the movable member of the linear actuator;
a cover member firmly fixed to the mounting member for providing a hermetic accommodation space wherein the linear actuator and the elastic connecting rubber are housed, the hermetic accommodation space are divided into a first air chamber formed on one side of the elastic connecting rubber and housing the linear actuator therein, and a second air chamber formed on an other side of the elastic connecting rubber; and
an air channel for permitting communication between the first air chamber and the second air chamber.

2. The active vibration damper according to claim 1, wherein the stator includes a stator side inner member firmly fixed to the stator, and the movable member includes a movable member side outer tubular member firmly fixed to the movable member and disposed coaxially with the stator side inner member while being spaced from each other in an axis-perpendicular direction, wherein the elastic connecting rubber is disposed between opposing faces between the stator side inner member and the movable member side outer tubular member for elastically connecting the stator and the movable member, and wherein a fixation shaft member extending in an axial direction is disposed such that both axial ends of the fixation shaft member are fixed to the cover member, and the stator side inner member is firmly fixed to the fixation shaft member.

3. The active vibration damper according to claim 2, wherein the movable member is disposed radially inwardly of the cover member with a given gap interposed therebetween in the axis-perpendicular direction, and the air channel is formed by utilizing the given gap between the movable member and the cover member.

4. The active vibration damper according to claim 2, wherein the stator side inner member has a through hole extending therethrough in an axial direction thereof, and another air channel is formed by using the through hole.

5. The active vibration damper according to claim 2, further comprises a stopper member fixed to a side of the stator and extends radially outwardly, and a stopper abutting portion fixed to a side of the movable member so as to project radially outwardly, wherein a distal end of the stopper member is disposed so as to be opposed to the stopper abutting portion from both sides in the direction of displacement of the movable member relative to the stator with a gap, in order to form a stopper mechanism to limit an amount of displacement of the movable member.

6. The active vibration damper according to claim 5, wherein the gap formed between the stopper member and the stopper abutting portion partially defines the air channel.

7. The active vibration damper according to claim 1, further comprising: an movable member side inner member firmly fixed to the movable member; and a stator side outer tubular member firmly fixed to the stator member and disposed coaxially with the movable member side inner member while being spaced from each other in an axis-perpendicular direction, wherein the elastic connecting rubber is disposed between opposing faces between the movable member side inner member and the stator side outer tubular member for elastically connecting the stator and the movable member, and wherein the movable member side inner member has a through hole extending therethrough in an axial direction thereof, and the air channel is formed by using the through hole.

8. The active vibration damper according to claim 7, wherein the movable member includes an inner tubular member extending in the axial direction and firmly fixed to the movable member side inner member, and wherein one axial open end of the inner tubular member is held in communication with the first air chamber, and an other axial open end of the inner tubular member is held in communication with the second air chamber through the through hole of the movable member side inner member so that the air channel is formed by utilizing a bore of the inner tubular member and the through hole of the movable member side inner member.

9. The active vibration damper according to claim 5, wherein the cover includes a cylindrical cover member fixed to the stator side outer tubular member and a cap member accommodating the actuator and firmly fitted onto a distal end of the cylindrical cover member, and wherein the distal end of the cylindrical cover member is provided with a stopper portion projecting radially inwardly so as to be opposed to the mass member in the direction of displacement of the movable member relative to the stator with a given gap in order to form a stopper mechanism to limit an amount of displacement of the movable member.

10. The active vibration damper according to claim 1, wherein the elastic connecting rubber hermetically partition the first air chamber and the second air chamber from each other.
